(19) United States
(12) Patent Application Publication
(10) Pub. No.: US 2008/0124159 A1
(43) Pub. Date: May 29, 2008

(54) Image forming apparatus

(75) Inventor: Takeshi Oyama, Tokyo (JP)

Correspondence Address: TAKEUCHI & KUBOTERA, LLP;SUITE 202, 200 DAINGERFIELD ROAD, ALEXANDRIA, VA, 22314, US

(73) Assignee: Oki Data Corporation

(21) Appl. No.: 11/984,758

(22) Filed: Nov. 21, 2007

(30) Foreign Application Priority Data
Nov. 29, 2006 (JP) 2006-322118

(51) Int. Cl. G03G 15/00

(52) U.S. Cl. 399/396

(57) ABSTRACT

An image forming apparatus includes an image forming unit for forming an image on a medium; a medium transportation unit for transporting the medium supplied from a medium supply unit to the image forming unit; a roller rotating after contacting with the medium transported from the medium transportation unit; a medium detection unit disposed on a downstream side of the roller in a medium transportation direction for detecting the medium; and a transportation speed adjusting unit for adjusting a transportation speed of the medium from when the roller starts rotating to when the medium detection unit on the downstream side detects the medium lower than a transportation speed at the image forming unit.

### BACKGROUND OF THE INVENTION AND RELATED ART STATEMENT

The present invention relates to an image forming apparatus.

Conventionally, in an image forming apparatus such as a printer, a copier, a facsimile, and an MFP (Multi-Function Product), a sheet transportation mechanism transports a sheet to a transportation path, so that the sheet is fed to a contact point of a pair of register rollers in a stationary state to correct a skew of the sheet (transportation skew). At this time, an entrance sensor is provided on an upstream side of the register rollers, so that the sheet is fed to the register rollers for an amount longer than a distance between the entrance sensor and the register rollers by a few millimeters. After the sheet is fed for the amount, it is controlled such that a sheet transportation operation is terminated.

In the following step, a register motor is driven to rotate the register rollers, so that the register rollers transport the sheet with the skew thus corrected. At the same time, an image forming unit performs an exposure process, so that a static latent image is formed. Then, when a writing sensor provided on a downstream side of the register rollers detects a front edge of the sheet, the sheets is transported at a controlled transportation speed, so that a toner image is transferred to the sheet thus transported in a synchronized operation according to a detection point or timing (refer to Patent Reference). Patent Reference Japanese Patent Publication No. 2005-352448

In the conventional printer, when a distance between the register rollers and the writing sensor is short or when a transportation speed is high, the front edge of the sheet may reach the writing sensor while a rotational vibration generated upon the register rollers rotating is not sufficiently decreased. Accordingly, the writing sensor may detect the front edge of the sheet while the transportation speed is uneven or fluctuated. As a result, the detection point may be fluctuated, and it is difficult to synchronize a transfer timing of the toner image, thereby causing deviation in a writing position of the front edge of the sheet and deteriorating image quality.

In view of the problems, described above, an object of the present invention is to provide an image forming apparatus capable of preventing deviation in a writing position of a front edge of a medium, thereby improving image quality.

Further objects will be apparent from the following description of the invention.

### SUMMARY OF THE INVENTION

In order to attain the objects described above, according to the present invention, an image forming apparatus comprises an image forming unit for forming an image on a medium; a medium transportation unit for transporting the medium supplied from a medium supply unit to the image forming unit; a roller rotating after contacting with the medium transported from the medium transportation unit; a medium detection unit disposed on a downstream side of the roller in a medium transportation direction for detecting the medium; and a transportation speed adjusting unit for adjusting a transportation speed of the medium from when the roller starts rotating to when the medium detection unit on the downstream side detects the medium lower than a transportation speed at the image forming unit.

In the present invention, the image forming apparatus comprises the image forming unit for forming the image on the medium; the medium transportation unit for transporting the medium supplied from the medium supply unit to the image forming unit; the roller rotating after contacting with the medium transported from the medium transportation unit; the medium detection unit disposed on the downstream side of the roller in the medium transportation direction for detecting the medium; and the transportation speed adjusting unit for adjusting the transportation speed of the medium from when the roller starts rotating to when the medium detection unit on the downstream side detects the medium lower than the transportation speed at the image forming unit.

In particular, the transportation speed adjusting unit adjusts the transportation speed of the medium from when the roller starts rotating to when the medium detection unit on the downstream side detects the medium lower than the transportation speed at the image forming unit. Accordingly, the media reach the medium detection unit on the downstream side after a rotational vibration generated upon the roller rotating is decreased. As a result, the medium detection unit on the downstream side detects the medium in a state the transportation speed has no unevenness or is not fluctuated, thereby causing little fluctuation in a detection point. Accordingly, it is easy to synchronize an image forming timing in the image forming unit, thereby preventing deviation in a writing position of the front edge of the medium and improving image quality.

### BRIEF DESCRIPTION OF THE DRAWINGS

FIG. 1 is a view showing a printer according to a first embodiment of the present invention;

FIG. 2 is a view showing a transportation transmitting unit of a transportation mechanism according to the first embodiment of the present invention;

FIG. 3 is a block diagram showing a control system of the printer according to the first embodiment of the present invention;

FIG. 4 is a flow chart showing an operation of transporting a sheet in the printer according to the first embodiment of the present invention;

FIG. 5 is a time chart showing the operation of transporting a sheet in the printer according to the first embodiment of the present invention;

FIG. 6 is a time chart showing an operation of transporting a sheet in a printer according to a comparative example of the present invention;

FIG. 7 is view showing a relationship between a transportation speed and fluctuation in a writing position according to the first embodiment of the present invention;

FIG. 8 is a view showing a transportation transmitting unit of a transportation mechanism according to a second embodiment of the present invention;

FIG. 9 is a flow chart showing an operation of transporting a sheet in a printer according to the second embodiment of the present invention; and

FIG. 10 is a time chart showing the operation of transporting the sheet in the printer according to the second embodiment of the present invention.

### DETAILED DESCRIPTION OF THE PREFERRED EMBODIMENTS

Hereunder, embodiments of the present invention will be explained with reference to the accompanying drawings. In the specification, a printer will be explained as an image forming apparatus.

### First Embodiment

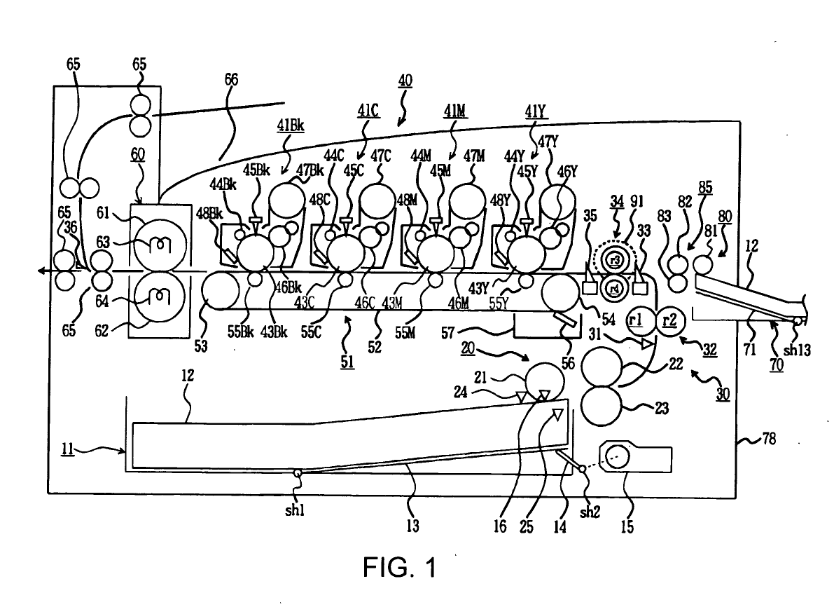

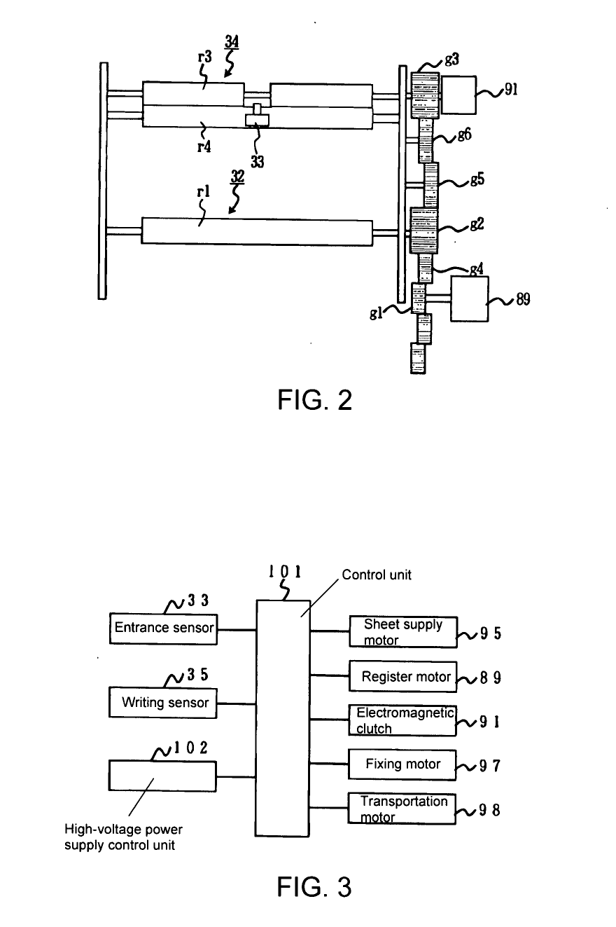

FIG. 1 is a view showing a printer according to a first embodiment of the present invention. FIG. 2 is a view showing a transportation transmitting unit of a transportation mechanism according to the first embodiment of the present invention. FIG. 3 is a block diagram showing a control system of the printer according to the first embodiment of the present invention.

As shown in FIG. 1, a sheet supply tray 11 or a first medium supply unit is arranged to be detachable from an apparatus body 78 of the printer. The sheet supply tray 11 retains sheets 12 as media therein. Further, the sheet supply tray 11 is provided with a medium placing plate 13, so that the sheets 12 are placed thereon. The medium placing plate 13 is rotatable around a shaft sh1.

In the embodiment, a guide member (not shown) is provided on the sheet supply tray 11 for regulating a loading position of the sheets 12. The guide member regulates and positions the sheets 12 while guiding side edges of the sheets 12 in a direction perpendicular to a transportation direction of the sheets 12.

In the embodiment, a lift-up lever 14 is provided on a feeding side or a front edge portion of the sheet supply tray 11 to be rotatable around a shaft sh2. Further, the shaft sh2 is connected with a motor 15 in a detachable manner. The motor 15 serves as a drive unit for loading the media. In this case, when the sheet supply tray 11 is stored in the apparatus body 78, the lift-up lever 14 engages with the motor 15.

When a control unit 101 drives the motor 15, the lift-up lever 14 is rotated. Then, a distal end of the lift-up lever 14 hits a bottom wall of the medium placing plate 13, so that a front edge of the medium placing plate 13 is lifted. Accordingly, a front edge of the sheets 12 loaded on the medium placing plate 13 is raised. When the front edge of the sheets 12 is raised to a specific height, a raising detection unit 16 detects the sheets 12, and sends a detection signal to the control unit 101. When the detection signal is received, the control unit 101 stops the motor 15 and the lift-up lever 14.

In the embodiment, a medium transportation unit 20 is provided in a front edge portion of the sheet supply tray 11 for transporting the sheet 12 one by one. The medium transportation unit 20 includes a pick-up roller 21; a feed roller 22; and a retard roller 23. The pick-up roller 21 or a feeding roller constitutes a feeding member for pressing the front edge of the sheets 12 thus raised to a specific height, and for feeding the sheets 12. The feed roller 22 as a first separation roller and a transportation mechanism is provided for separating the sheets 12 fed by the pick-up roller 21. The retard roller 23 is a second separation roller and a retard mechanism. The feed roller 22 and the retard roller 23 constitute a separation unit.

In the embodiment, the feeding portion 20 is provided with a medium detection unit 24 and a remaining medium detection unit 25. The medium detection unit 24 detects whether the sheets 12 are loaded. The remaining medium detection unit 25 detects remaining sheets and is situated somewhat below the raising detection unit 16.

The sheets 12 fed by the medium transportation unit 20 and separated by the feed roller 22 and the retard roller 23 are fed to a transportation path of a first medium transportation unit 30. Further, the sheets 12 pass through a medium sensor 31 or a first medium detection unit at the first medium transportation unit 30. Further, after the medium sensor 31 detects the front edge, the sheets 12 are fed to a transportation roller pair 32 or a first roller pair comprising rollers r1 and r2. When the medium sensor 31 detects the front edge of the sheets 12, a detection signal is sent to the control unit 101. The transportation roller pair 32 is rotated with a register motor 89 or a first drive unit.

In the embodiment, the sheets 12 fed from the transportation roller pair 32 pass through an entrance sensor 33. The entrance sensor 33 is a medium detection unit situated on an upstream side or a second medium detection unit. After the entrance sensor 33 detects the front edge, the sheets 12 are fed to a register roller 34. The register roller 34 is a second roller pair comprising rollers r3 and r4 and corrects skew. In the register roller 34, one of the rollers r3 or r4 is formed of a high frictional member such as rubber, and the other is formed of a low frictional member such as metal or plastic.

In the embodiment, the sheets 12 fed from the register roller 34 pass through a writing sensor 35. The writing sensor 35 is a medium detection unit situated on a downstream side or a third medium detection unit. After the writing sensor 35 detects the front edge, the sheets 12 are fed to an image forming unit 40.

In the embodiment, the entrance sensor 33 is provided near an upstream side of the register roller 34 in a transportation direction of the sheets 12. The writing sensor 35 is provided near a downstream side of the register roller 34 in the transportation direction of the sheets 12. Both the entrance sensors 33 and 34 send a detection signal to the control unit 101 when the front edge of the sheets 12 is detected. A distance between the entrance sensor 33 and the register roller 34, and the register roller 34 and the writing sensor 35 are set to be approximately 8.0 mm.

The image forming unit 40 has four image forming units 41Y, 41M, 41C, and 41Bk arranged in line; and a transfer unit 51 for transferring a toner image formed by the image forming units 41Y, 41M, 41C, and 41Bk to the sheets 12 through Coulomb force, so that an image is formed on the sheet 12.

The image forming unit 41Y comprises a photoreceptor drum 43Y; a charging roller 44Y; a print head 45Y; a developing roller 46Y; a toner supply portion 47Y; and a cleaning blade 48Y. The photoreceptor drum 43Y is an image supporting member to support the toner image. The charging roller 44Y is a charging apparatus and charges a surface of the photoreceptor drum 43Y. The print head 45Y is an exposure device to expose a surface of the photoreceptor drum 43Y thus charged and to form a static latent image. The developing roller 46Y is a developing member to form a yellow toner image on the static latent image through friction charging. The toner supply portion 47Y supplies yellow toner as a developer. The cleaning blade 48Y is a cleaning apparatus to remove residual toner on the photoreceptor drum 43Y.

The image forming unit 41M comprises a photoreceptor drum 43M; a charging roller 44M; a print head 45M; a developing roller 46M; a toner supply portion 47M; and a cleaning blade 48M. The photoreceptor drum 43M is an image supporting member to support the toner image. The charging roller 44M is a charging apparatus and charges a surface of the photoreceptor drum 43M. The print head 45M is an exposure device to expose a surface of the photoreceptor drum 43M thus charged and to form a static latent image. The developing roller 46M is a developing member to form a magenta toner image on the static latent image through friction charging. The toner supply portion 47M supplies magenta toner as a developer. The cleaning blade 48M is a cleaning apparatus to remove residual toner on the photoreceptor drum 43M.

The image forming unit 41C comprises a photoreceptor drum 43C; a charging roller 44C; a print head 45C; a developing roller 46C; a toner supply portion 47C; and a cleaning blade 48C. The photoreceptor drum 43C is an image supporting member to support the toner image. The charging roller 44C is a charging apparatus and charges a surface of the photoreceptor drum 43C. The print head 45C is an exposure device to expose a surface of the photoreceptor drum 43C thus charged and to form a static latent image. The developing roller 46C is a developing member to form a cyan toner image on the static latent image through friction charging. The toner supply portion 47C supplies cyan toner as a developer. The cleaning blade 48C is a cleaning apparatus to remove residual toner on the photoreceptor drum 43C.

The image forming unit 41Bk comprises a photoreceptor drum 43Bk; a charging roller 44Bk; a print head 45Bk; a developing roller 46Bk; a toner supply portion 47Bk; and a cleaning blade 48Bk. The photoreceptor drum 43Bk is an image supporting member to support the toner image. The charging roller 44Bk is a charging apparatus and charges a surface of the photoreceptor drum 43Bk. The print head 45Bk is an exposure device to expose a surface of the photoreceptor drum 43Bk thus charged and to form a static latent image. The developing roller 46Bk is a developing member to form a black toner image on the static latent image through friction charging. The toner supply portion 47Bk supplies black toner as a developer. The cleaning blade 48Bk is a cleaning apparatus to remove residual toner on the photoreceptor drum 43Bk.

Each of the print heads 45Y, 45M, 45C, and 45Bk is provided with an LED array. Further, the transfer unit 51 is provided with a transportation motor 98; a drive roller 53; a tension roller 54; a transfer belt 52; transfer rollers 55Y, 55M, 55C, and 55Bk; a cleaning blade 56; a toner box 57; and the likes.

The transportation motor 98 is a drive unit to feed the sheet 12. The drive roller 53 is provided to be rotatable and is rotated by driving the transportation motor 98. The tension roller 54 is provided to be rotatable while keeping a specific distance with respect to the drive roller 53. The transfer belt 52 is a feeding member to feed the sheet 12 through an electrostatic adsorption and is provided between the drive roller 53 and the tension roller 54. Further, the transfer belt 52 moves along with a rotation of the drive roller 53. The transfer rollers 55Y, 55M, 55C, and 55Bk are a transfer device to transfer the toner images to the sheets 12 and are provided to face with the image forming units 41Y, 41M, 41C, and 41Bk, and to press against the photoreceptor drum 43Y, 43M, 43C and 43Bk. The cleaning blade 56 scrapes off toner adhered to the transfer belt 52 to clean. The toner box 57 is a developer container to contain the toner scraped off by the cleaning blade 56.

The image forming units 41Y, 41M, 41C, and 41Bk and the transfer belt 52 are operated in a synchronized manner. Accordingly, the toner images in each color are transferred to the sheets 12 on the transfer belt 52 in series sequentially to form color toner images. Then, the sheets 12 with the color toner images are fed to a fixing device 60.

The fixing device 60 comprises a roller pair of an upper roller 61 or a first roller with a surface made of an elastic member, and a lower roller 62 or a second roller. The upper roller 61 is provided with a halogen lamp 63 or a first heat source, while the lower roller 62 is provided with a halogen lamp 64 or a second heat source. The upper roller 61 is rotated through driving a fixing motor or a driving portion for fixing (not shown).

In the fixing device 60, the color toner images on the sheets 12 sent from the image forming unit 40 are heated and pressed to fix the color toner images to the sheets 12. Then, the sheets 12 sent from the fixing device 60 are ejected to either a stacker portion 66 or a rear tray (not shown). A separator 36 or a transportation switching device directs the sheets 12 to eject to an upper portion or a straight direction. Further, a plurality of discharge roller pair 65 is provided at specific positions designated on a transportation path.

When a discharge direction is an upper direction, the discharge roller pair 65 ejects the sheets 12 to the stacker portion 66 formed on a top surface of the apparatus body 78. On the other hand, when the discharge direction is a straight direction, the sheets 12 are ejected to the rear tray (not shown) formed on a side surface of the apparatus body 78.

In the embodiment, standard paper may be fed from the sheet supply tray 11 as the sheets 12. A sheet supply tray 70 and a medium transportation unit 80 are provided to feed the sheets 12 such as a cardboard, a postcard, an envelop, or the like that the sheet supply tray 11 cannot feed. The sheet supply tray 70 is a second medium supply unit extended from the apparatus body 78 to supply the sheets 12 to the image forming unit 40.

The sheet supply tray 70 is provided to be rotatable around the apparatus body 78. The sheet supply tray 70 is open when in use and closed when idle. Further, the sheet supply tray 70 functions as an MPT (Multi-Purpose Tray) or a manual tray. The sheet supply tray 70 is rotatable around a shaft sh13 and provided with a medium placing plate 71 or the like to load and move the sheets 12 up and down.

The medium transportation unit 80 is provided corresponding to the sheet supply tray 70 at the apparatus body 78. Further, the medium transportation unit 80 has a pick-up roller 81 and a separation unit (not shown). The pick-up roller 81 is a feeding roller to constitute a feeding member to feed the sheets 12. The separation unit is a separation member to separate the sheets 12 fed by the pick-up roller 81 one by one.

A transportation roller pair 85 is provided on the register roller 34 on a side of the medium transportation unit 80. The transportation roller pair 85 is a second medium transportation unit comprising rollers 82 and 83, and is a first roller pair. Further, the medium transportation unit 80 is provided with a medium detection unit (not shown) to detect the sheets 12.

In the medium transportation unit 80, the pick-up roller 81 feeds the sheets 12 from the sheet supply tray 70. Further, the separation unit separates the sheets 12 one by one, and directs the sheets 12 to the transportation path. The paper sheet transportation mechanism comprises the sheet supply tray 11; the medium transportation unit 20; the first medium transportation unit 30; the medium transportation unit 80; the transportation roller pair 85; and the like.

As shown in FIG. 2, a gear g1 is provided on an axis of the register motor 89. A gear g2 is provided on an axis of the roller r1 of the transportation roller pair 32. A gear g3 and an electromagnetic clutch 91 are provided on an axis of a roller r3 of the register roller 34. The register motor 89 and the roller r1 are connected through the gears g1, g4, and g2. The register motor 89 and the roller r3 are connected through the gears g1, g4, g2, g5, g6, and g3, and the electromagnetic clutch 91.

Accordingly, when the register motor 89 rotates, the rotation is transmitted to the transportation roller pair 32 through the gears g1, g4, and g2, and to the electromagnetic clutch 91 through the gears g5, g6, and g3. The electromagnetic clutch 91 is turned on and off to rotate the register roller 34, so that the rotation received by the gear g3 is selectively transmitted to the register roller 34. When the register motor 89 rotates, the rotation is transmitted to the rollers 82 and 83 through another gear (not shown). The electromagnetic clutch 91 functions as an actuator to rotate the register roller 34.

As shown in FIG. 3, in addition to the register motor 89 and the electromagnetic clutch 91, the control unit 101 is connected to a sheet supply motor 95 to rotate the pick-up roller 21; a fixing motor 97 to rotate the upper roller 61; a transportation motor 98 to move the transfer belt 52; the entrance sensor 33; the writing sensor 35; and a high-voltage power supply control unit 102, so that to control unit 101 controls the entire printer. Further, the high-voltage power supply control unit 102 supplies a specific voltage to each of the image forming units 41Y, 41M, 41C, and 41Bk.

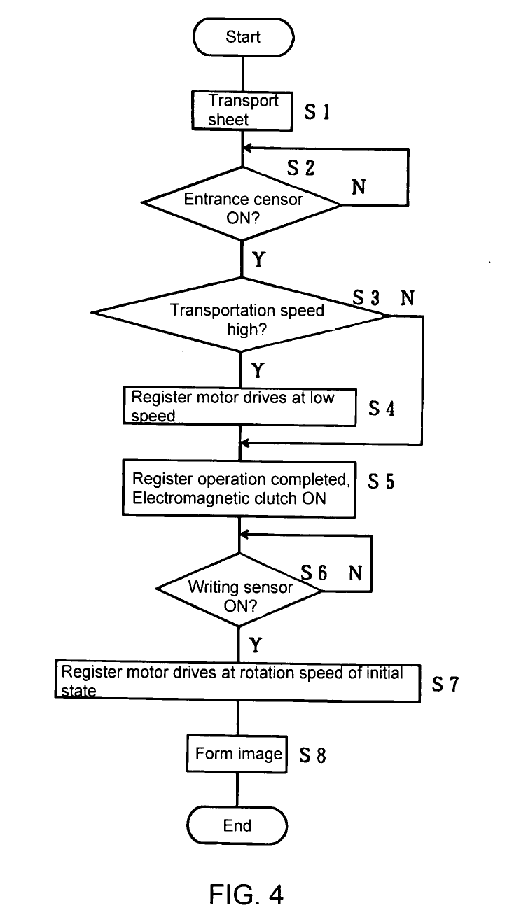

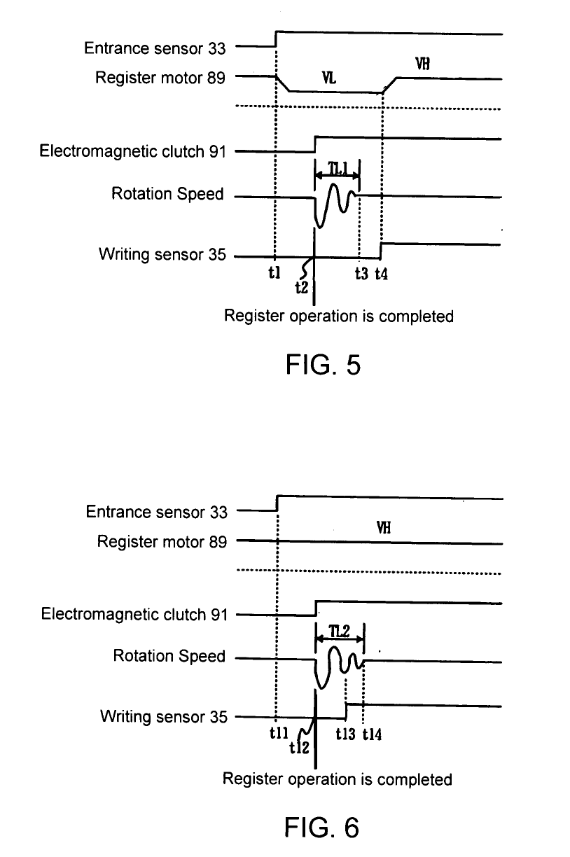

Next, an operation of the printer will be explained. FIG. 4 is a flow chart showing an operation of transporting the sheet in the printer according to the first embodiment of the present invention. FIG. 5 is a time chart showing the operation of transporting the sheet in the printer according to the first embodiment of the present invention

When a host device such as a personal computer instructs the printer to print according to an operation of an operator, the control unit 101 (FIG. 3) selects one of the sheet supply trays 11 or 70 as a paper feeding portion suitable for a printing condition such as a paper size and a type of the sheets 12 (FIG. 1).

When the sheet supply tray 11 is selected, the lift-up lever 14 raises the front edge of the sheets 12 loaded on the medium placing plate 13 inside the sheet supply tray 11 to a specific height so as to press the front edge of the sheets 12 to the medium transportation unit 20. Accordingly, the medium transportation unit 20 sends a sensor output to the control unit 101.

When the control unit 101 receives the sensor output from the medium transportation unit 20, the detecting signal (sheet supply start signal) is sent to the sheet supply motor 95 to drive the sheet supply motor 95 to rotate the pick-up roller 21 in a counterclockwise direction. Accordingly, an uppermost one of the sheets 12 is fed to the transportation path through a frictional force of the pick-up roller 21. When more than two of the sheets 12 are fed, the feed roller 22 and the retard roller 23 separate the sheets to one sheet.

In the next step, the sheet 12 is transported to the transportation roller pair 32, so that the transportation roller pair 32 transports the sheet 12 to the register roller 34 at a specific speed. In this operation, a transportation processing unit (not shown) of the control unit 101 processes the transportation process. That is, the transportation processing unit determines a type of the sheet 12 from the print instruction transmitted from the host device. Then, the transportation processing unit refers to a rotation speed table provided in a storage unit (not shown), and reads a rotation speed of the register motor 89 corresponding to a type of the sheet 12, so that the register motor 89 rotates at the rotation speed. Accordingly, the sheet 12 is transported at a transportation speed corresponding to the rotation speed of the register motor 89 and is sent to the register roller 34. Note that the transportation speed of the sheets 12 represents an image forming speed. In the image forming unit 40, the sheet 12 is fed to form an image.

When the sheet supply tray 70 is selected, the transportation processing unit refers to the rotation speed table to read a rotation speed of the register motor 89 corresponding to a type of the sheet 12, so that the register motor 89 rotates at the rotation speed. Accordingly, the transportation roller pair 85 transports the sheets 12 to the register roller 34 at the transportation speed corresponding to the rotation speed of the register motor 89.

In the embodiment, in order to correct a skew of the sheet 12, at an initial state, the electromagnetic clutch 91 is turned off, and the register roller 34 is terminated. Accordingly, a register operation is performed at the register roller 34.

In a skew correcting process, a skew correction processing unit (not shown) of the control unit 101 observes a status of the entrance sensor 33 to determine whether the front edge of the sheet 12 reaches the entrance sensor 33. When the front edge of the sheet 12 reaches the entrance sensor 33 at a timing t1, the skew correction processing unit starts the register operation. That is, the skew correction processing unit transports the sheet 12 for a distance longer than a distance from the entrance sensor 33 to the register roller 34 by a few millimeters as a margin, so that the sheet 12 has a loop. Then, the entire front edge (front side) of the sheet 12 is pushed against the rollers r3 and r4, thereby correcting the skew.

In the skew correcting process, the register motor 89 is driven, while the electromagnetic clutch 91 is turned off to disconnect a connection between the gear g3 (FIG. 2) and the register roller 34. Accordingly, only the transportation roller pair 32 rotates through the rotation of the register motor 89 to transport the sheet 12, while the register roller 34 remains stopped.

In the next step, a speed determination processing unit (not shown) of the control unit 101 performs a speed determination process and determines whether the transportation speed of the sheets 12 is high.

In the speed determination process, the speed determination processing unit determines a type of the sheet 12 and refers to the transportation speed table provided in the storage unit to determine whether the transportation speed is high based on a type of the sheets 12. In the transportation speed table, the types of the sheets 12 and the transportation speeds are recorded corresponding to each other.

In the embodiment, when a regular sheet is used as the sheets 12, the transportation speed is set to be high (150 mm/sec). On the other hand, when a special sheet such as a cardboard, a postcard, an envelop, or the like is used, the transportation speed is set to be low (100 mm/sec).

In the embodiment, the speed determination processing unit determines whether the transportation speed is high based on the type of the sheets 12. Alternatively, an encoder (not shown) as a speed detection portion detects the rotation speed of the register motor 89, so that the speed determination processing unit determines whether the transportation speed is high based on the rotation speed. Alternatively, it may be determined whether the transportation speed is high based on a fixing speed represented by a rotation speed of a fixing motor, a tray in use (tray in use), and an discharge direction as shown in Table 1.

TABLE 1

| Type of | Transportation | Fixing | | Discharge |
|---|---|---|---|---|
| sheet | speed | speed | Tray in use | direction |
| Regular | High | High | Sheet supply | Upper |
| | | | tray 11 | |
| Cardboard, | Low | Low | Sheet supply | Straight |
| postcard, | | | tray 70 | |
| envelope, | | | | |
| etc. | | | | |

As shown in Table 1, when the fixing speed is high; the sheet supply tray 11 is used; and the discharge direction is an upper direction, the transportation speed is determined to be high. On the other hand, when the fixing speed is low; the sheet supply tray 70 is used; and the discharge direction is straight, the fixing speed is determined to be low.

When the transportation speed is determined to be high, (determined to be high in FIG. 5), the transportation speed adjusting unit (not shown) of the control unit 101 performs a speed adjusting process. That is, the transportation speed adjusting unit changes a drive of the register motor 89; lowers the rotation speed VH to VL; and drives the register motor 89 at a low speed. On the other hand, when the transportation speed is determined to be low, the transportation speed adjusting unit does not change the drive of the register motor 89 and keeps the drive at a low speed.

After a specific period of time passes and the skew of the sheets 12 is corrected, the skew correction processing unit completes the register operation to turn on the electromagnetic clutch 91 at the timing t2. Accordingly, the gear g1 and the register roller 34 are connected to rotate the register roller 34, and the sheet 12 is transported toward the transfer unit 51 on a downstream side.

When the electromagnetic clutch 91 is turned on, the register roller 34 momentary receives all loads of the drive system connected through the electromagnetic clutch 91 and the gears, so that a rotational vibration is generated in the register roller 34. At this time, the rotation speed VL of the register motor 89 is so low. Accordingly, the rotational vibration of the register roller 34 is drastically decreased, and the rotational vibration is completely eliminated at a timing t3 after a time TL1.

In the next step, the skew correction processing unit (not shown) of the control unit 101 observes the status of the entrance sensor 33 to determine whether the front edge of the sheet 12 reaches the entrance sensor 33. When the writing sensor 35 is turned on at a timing t4, the register motor 89 is driven at a rotation speed at an initial state. Accordingly, the speed determination processing unit determines whether the register motor 89 is driven at a high speed before the speed adjusting process.

When the register motor 89 is driven at a high speed (driven at a high speed in FIG. 5), the transportation speed adjusting unit changes the drive of the register motor 89; increases the rotation speed VL to VH; and drives the register motor 89 at a high speed. On the other hand, when the register motor 89 is driven at a low speed, the transportation speed adjusting unit does not change the drive of the register motor 89, and keeps the speed at low. Accordingly, the transportation speed at the image forming unit 40 is the one in the initial state.

At this time, the register roller 34 does not generate the rotational vibration. Accordingly, even if the register roller 89 is driven at a high speed, the transportation speed of the sheets 12 has no unevenness or fluctuations.

Accordingly, when the front edge of the sheet 12 reaches the entrance sensor 33, the transportation speed of is set at a slow speed. Then, when the front edge of the sheet 12 passes through the writing sensor 35, the transportation speed returns to the original transportation speed; that is, the transportation speed to form an image at the image forming unit 40.

Then, the transportation processing unit controls the rotation speed of the register roller 34 to control the transportation speed of the sheet 12. Accordingly, it is possible to synchronize a timing of transferring a toner image; that is, a timing to form an image, with the sheet 12 thus transported based on the detection point representing the timing for the writing sensor 35 to detect the front edge of the sheet 12. Accordingly, when the sheet 12 is fed to the transfer unit 51, an image is formed at the image forming unit 40.

As described above, in the embodiment, the register operation is completed at the timing t2. After the rotational vibration generated when the register roller 34 starts rotating is decreased, the front edge of the sheet 12 reaches the writing sensor 35 to turn on the writing sensor 35. Accordingly, the writing sensor 35 detects the front edge of the sheet 12 without unevenness or fluctuations of the transportation speed. Therefore, no error is observed on detection and the transfer timing of toner images may be synchronized with ease.

As a result, deviations in a writing position of the front edge of the sheet 12 are prevented, thereby improving image quality. Further, it is possible to shorten a range in which the transportation speed is low (from when the front edge of the sheet 12 reaches the entrance sensor 33 to when the front edge of the sheet 12 reaches the writing sensor 35), thereby minimizing an influence on a total throughput.

Next, the flow chart shown in FIG. 3 will be explained. In Step S1, the sheet 12 is transported. In Step S2, the process becomes idle until the entrance sensor 33 is turned on. In Step S3, it is determined whether the transportation speed is high. When the transportation speed is high, the process proceeds to Step S4. When the transportation speed is not high (low), the process proceeds to Step S5.

In Step S4, the register motor 89 is driven at a low speed. In Step S5, the register operation is completed, and the electromagnetic clutch 91 is turned on. In Step S6, the process becomes idle until the writing sensor 35 is turned on. In Step S7, the register motor 89 is driven at the rotation speed of the initial state. In Step S8, an image is formed and the process is completed.

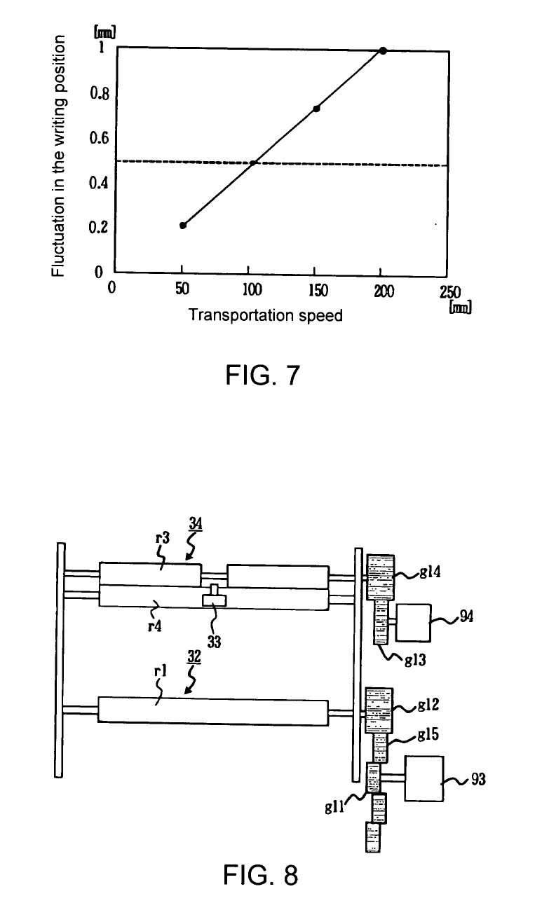

FIG. 6 is a time chart showing an operation of transporting a sheet in a printer according to a comparative example of the present invention. FIG. 7 is view showing a relationship between the transportation speed and fluctuation in the writing position according to the first embodiment of the present invention.

As shown in FIG. 6, in the comparative example, when the entrance sensor 33 is turned on at a timing t11, the rotation speed of the register motor 89 is maintained to be high at the rotation speed VH. When the register operation is completed at a timing t12 and the electromagnetic clutch 91 is turned on, the rotational vibration of the register roller 34 (FIG. 1) is generated. In this case, the rotation speed VH of the register motor 89 remains high, and the register roller 34 receives a high load. Accordingly, the rotational vibration generated at the register roller 34 is decreased for a time TL2 longer than the time TL1, and there is no rotational vibration at a timing t14.

Then, the writing sensor 35 is turned on at a timing t13. However, the time TL2 does not pass at this point, and the rotational vibration of the register roller 34 is decreased completely. Accordingly, an image is formed while the transportation speed of the sheets 12 is uneven and fluctuated.

As shown in FIG. 7, when the transportation speed is higher upon turning on the electromagnetic clutch 91, the fluctuation in the writing position where the image is formed on the sheet 12 becomes greater.

In the embodiment, when the transportation speed VL of the register roller 34 is lowered to approximately 100 mm/s upon starting the register motor 34 to rotate, it is possible to maintain the fluctuation in the writing position 0.5 mm or less. When the fluctuation in the writing position is 0.5 mm or less, the fluctuation in the writing position becomes hardly noticeable.

### Second Embodiment

A second embodiment of the present invention will be explained next. Components in the second embodiment similar to those in the first embodiment are designated with the same reference numerals. A configuration in the second embodiment similar to that in the first embodiment provides a similar effect.

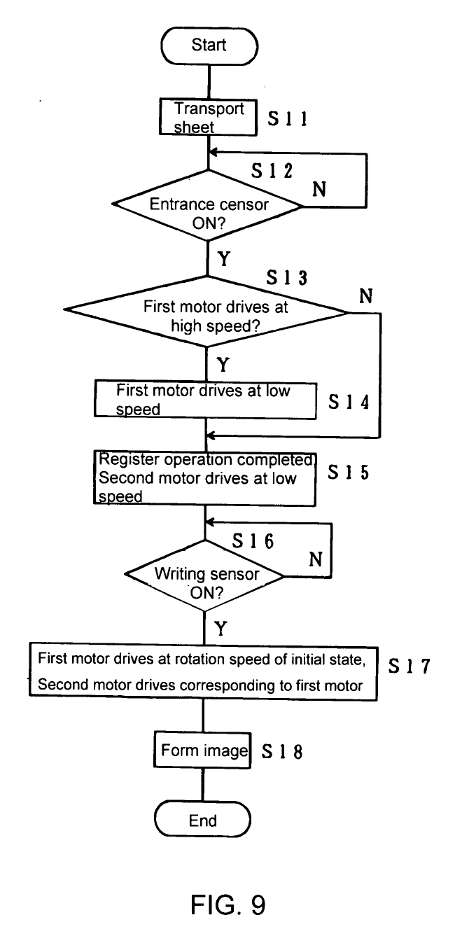

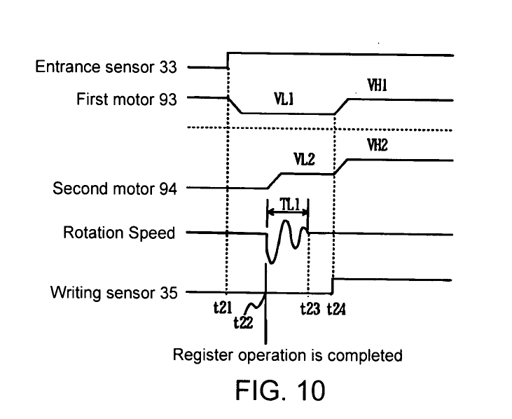

FIG. 8 is a view showing a transportation transmitting unit of a transportation mechanism according to the second embodiment of the present invention. FIG. 9 is a flow chart showing an operation of transporting a sheet in a printer according to the second embodiment of the present invention. FIG. 10 is a time chart showing the operation of transporting the sheet in the printer according to the second embodiment of the present invention.

In the embodiment, as shown in FIG. 8, a first motor 93 or a first driving portion is provided to rotate the transportation roller pair 32 or the first roller pair. Further, a second motor 94 or a second driving portion as an actuator is provided to rotate the register roller 34 or the second roller pair. The first motor 93 feeds the sheets 12 as the media, while the second motor 94 corrects the skew of the sheets 12.

In the embodiment, a gear g11 is provided on an axis of the first motor 93. A gear g12 is provided on an axis of the roller r1 of the transportation roller pair 32. A gear g13 is provided on an axis of the second motor 94. A gear g14 is provided on an axis of the roller r3 of the register roller 34. Further, the first motor 93 and the roller r1 are connected through the gears g11, g15, and g12, and the second motor 94 and the roller r3 are connected through the gears g13 and g14. Accordingly, rotations of the first motor 93 are transmitted to the transportation roller pair 32 through the gears g11, g15, and g12, and rotations of the second motor 94 are transmitted to the register roller 34 through the gears 13 and 14.

Next, an operation of the printer will be explained. When the sheet 12 is fed from the sheet supply tray 11 (FIG. 1) as the first medium supply unit, the sheet 12 is transported to the transportation roller pair 32, so that the transportation roller pair 32 transports the sheet 12 to the register roller 34 at a specific speed. Therefore, the transportation processing unit of the control unit 101 (FIG. 3) determines a type of the sheet 12 from the print instruction transmitted from the host device. Then, the transportation processing unit refers to the rotation speed table, and read the rotation speed of the first motor 93 corresponding to the type of the sheet 12, thereby rotating the first motor 93 at the rotation speed. Accordingly, the sheet 12 is fed at a transportation speed corresponding to the rotation speed of the first motor 93 and is sent to the register roller 34.

In order to correct the skew of the sheet 12, at an initial state, the second motor 94 and the register roller 34 are stopped. Accordingly, the register operation may be performed at the register roller 34.

The skew correction processing unit of the control unit 101 observes the status of the entrance sensor 33 or the second medium detection unit to determine whether the front edge of the sheet 12 reaches the entrance sensor 33. When the front edge of the sheet 12 reaches the entrance sensor 33 at a timing t21, the skew correction processing unit starts the register operation and feeds the sheet 12 for a distance longer than a distance from the entrance sensor 33 to the register roller 34 by a few millimeters, so that the sheet 12 has a loop. Then, the entire front edge of the sheet 12 is pushed to the rollers r3 and r4 to correct the skew.

During the register process, the first motor 93 is driven, while the second motor 94 is turned off. Accordingly, only the transportation roller pair 32 is rotated by a rotation of the first motor 93 to feed the sheet 12, while the register roller 34 remains stopped.

In the next step, the speed determination processing unit of the control unit 101 determines whether the transportation speed of the sheets 12 is high.

In the process, the speed determination processing unit reads a type of the sheet 12. Then, the speed determination processing unit refers to the transportation speed table to determine whether the transportation speed is high based on the type of the sheets 12. In the transportation speed table, the types of the sheets 12 and the transportation speeds are recorded corresponding to each other.

When the transportation speed is determined to be high, (determined to be high in FIG. 10), the transportation speed adjusting unit of the control unit 101 changes a drive of the first motor 93; lowers the rotation speed VH1 to VL1; and drives the first motor 93 at a low speed. On the other hand, when the transportation speed is determined to be low, the transportation speed adjusting unit does not change the drive of the first motor 93 and keeps the drive at a low speed.

After a specific time passes and the skew of the sheets 12 is corrected, the skew correction processing unit completes the register operation; drives the second motor 94 at a low speed; and changes the rotation speed to VL2. Accordingly, the register roller 34 is rotated and the sheet 12 is fed toward the transfer unit 51 on the downstream side at the same transportation speed.

In this case, when the second motor 94 is driven, all loads of the drive system comprising the gears 13 and 14 are applied to the register roller 34 momentary, thereby generating a rotational vibration in the register roller 34. AT this moment, the rotation speed VL2 of the second motor 94 is low, so that the rotational vibration of the register roller 34 is drastically decreased. Accordingly, the rotational vibration is lost at a timing t23 after a time TL1.

In the next step, the skew correction processing unit (not shown) of the control unit 101 observes the status of the entrance sensor 33 to determine whether the front edge of the sheet 12 reaches the entrance sensor 33. When the writing sensor 35 is turned on at a timing t24, the first motor 93 is driven at a rotation speed in the initial state. Accordingly, the speed determination processing unit determines whether the first motor 93 is driven at a high speed before the speed adjusting process.

When the first motor 93 is driven at a high speed (driven at a high speed in FIG. 10), the transportation speed adjusting unit changes the drive of the first motor 93; increases the rotation speed VL1 to VH1, and drives the first motor 93 at a high speed. On the other hand, when the first motor 93 is driven at a low speed, the transportation speed adjusting unit does not change the drive of the first motor 93, and keeps the speed at low.

Further, the transportation speed adjusting unit drives the second motor 94 at a high speed to synchronize with the first motor 93 so as to transport the sheet 12 at the same speed. In the embodiment, the drive of the second motor 94 is changed and the rotation speed VL2 is changed to VH2. At this time, the register roller 34 does not generate the rotational vibration. Accordingly, even if the second motor 94 is driven at a high speed, the transportation speed of the sheets 12 has no unevenness or fluctuations.

In the embodiment, when the first and second motors 93 and 94 are driven at a rotation speed of VL1 and VL2, respectively, the transportation roller pair 32 and the register roller 34 feed the sheet 12 at the same speed. Similarly, when the first and second motors 93 and 94 are driven at the rotation speeds of VH1 and VH2, the transportation roller pair 32 and the register roller 34 feed the sheet 12 at the same speed.

Then, the transportation processing unit controls the rotation speed of the first and second motors 93 and 94 to control the transportation speed of the sheets 12 based on the detection point representing the timing for the writing sensor 35 to detect the front edge of the sheets 12. Accordingly, it is possible to synchronize a timing of transferring a toner image with the sheet 12. Accordingly, when the sheet 12 is fed to the transfer unit 51, an image is formed at the image forming unit 40.

As described above, in the embodiment, the register operation is completed at a timing t22. After the rotational vibration generated upon starting the second motor 94 is decreased, the front edge of the sheet 12 reaches the writing sensor 35 to turn on the writing sensor 35. Accordingly, the writing sensor 35 detects the front edge of the sheet 12 without unevenness or fluctuation in the transportation speed. Therefore, no error will be observed on detection and the transfer timing of toner images may be synchronized with ease.

As a result, deviations in a writing position of the front edge of the sheet 12 are prevented, thereby improving image quality. Further, it is possible to shorten a range in which the transportation speed is low (from when the front edge of the sheet 12 reaches the entrance sensor 33 to when the front edge of the sheet 12 reaches the writing sensor 35), thereby minimizing an influence on a total throughput.

In the embodiment, the first and second motors 93 and 94 are independently provided. Accordingly, when the second motor 94 is driven at a timing t22, only a load of the gears g13 and g14, and the register roller 34 is applied to the second motor 94. Accordingly, when the register roller 34 starts rotating, the rotational vibration thus generated may be smaller than that in the first embodiment. Further, it is possible to shorten the time TL1 to reduce the rotational vibration.

As a result, in the second embodiment, while the accuracy of the write position is maintained, the rotation speed VL1 and VL2 may be increased slightly higher than the rotation speed VL. The rotation speed VL1 and VL2 are the rotation speed to drive the first and second motors 93 and 94 at a low speed. The rotation speed VL is the rotation speed to drive the register motor 89 at a low speed in the first embodiment. Accordingly, print throughput may be improved.

Further, different from the first embodiment, it is not necessary to provide the gear to connect the transport roller pair 32 and the register roller 34. Accordingly, the number of the members and the cost of the printer may be reduced.

Next, a flow chart shown in FIG. 9 will be explained. In Step S1, the sheet 12 is transported. In Step S2, the process becomes idle until the entrance sensor 33 is turned on. In Step S13, it is determined whether the first motor 93 is driven at the high speed. When the first motor 93 is driven at the high speed, the process proceeds to Step S14. When the first motor 93 is not driven at the high speed (the low speed), the process proceeds to Step S15.

In Step S14, the first motor 93 is driven at the low speed. In Step S15, the register operation is completed, and the second motor 94 is driven at the low speed. In Step S16, the process becomes idle until the writing sensor 35 is turned on. In Step S17, the first motor 93 is driven at the rotation speed of the initial state, and the second motor 94 is driven corresponding to the first motor 93. In Step S18, an image is formed and the process is completed.

In the embodiments described above, the printer is explained as an image forming apparatus, and the present invention is applicable to a copier, a facsimile, or an MFP (Multi-Function Product) provided with functions of a copier and a facsimile.

The present invention is not limited to the embodiments described above. Various changes may be made to the present invention without departing from the scope of the invention.

The disclosure of Japanese Patent Application No. 2006-322118, filed on Nov. 29, 2006, is incorporated in the application by reference.

While the invention has been explained with reference to the specific embodiments of the invention, the explanation is illustrative and the invention is limited only by the appended claims.

What is claimed is:

1. An image forming apparatus comprising:
an image forming unit for forming an image on a medium;
a medium transportation unit for transporting the medium supplied from a medium supply unit to the image forming unit;
a roller rotating after contacting with the medium transported from the medium transportation unit;
a first medium detection unit disposed on a downstream side of the roller in a medium transportation direction for detecting the medium; and
a transportation speed adjusting unit for adjusting a first transportation speed of the medium from when the roller starts rotating to when the first medium detection unit detects the medium lower than a second transportation speed at the image forming unit.

2. The image forming apparatus according to claim 1, further comprising a second medium detection unit disposed on an upstream side of the roller in the medium transportation direction, said transportation speed adjusting unit adjusting a third transportation speed from when the second medium detection unit detects the medium to when the first medium detection unit detects the medium lower than the second transportation speed at the image forming unit.

3. The image forming apparatus according to claim 1, further comprising a first drive unit for transporting the medium at the medium transportation unit, and an actuator for rotating the roller.

4. The image forming apparatus according to claim 3, wherein said actuator includes an electromagnetic clutch for transmitting a rotation of the first drive unit to the roller.

5. The image forming apparatus according to claim 3, wherein said actuator includes a second drive unit.
